(19) United States
(12) Patent Application Publication
(10) Pub. No.: US 2022/0329737 A1
(43) Pub. Date: Oct. 13, 2022

(54) 3D POLYGON SCANNER

(71) Applicant: OKIBO LTD, Petach Tikva (IL)

(72) Inventors: Lior Zaibel, Tel Aviv (IL); Ron Danon, Tel Aviv (IL); Guy German, Magal (IL)

(73) Assignee: OKIBO LTD, Petach Tikva (IL)

(21) Appl. No.: 17/228,721

(22) Filed: Apr. 13, 2021

(51) Int. Cl. H04N 5/232; G06T 7/73; H04N 13/296

(52) U.S. Cl. CPC H04N 5/23299; G06T 7/73; H04N 13/296

(57) ABSTRACT

Some embodiments of the current invention relate to a 3D scanner that models while scanning. For example, the device may recognize common objects and/or edges while scanning. For example, the scanner may create a boundary representation (B-rep) model as it scans. Optionally, the scanner is configured to take advantage of common features on a specific environment. For example, an indoor building scanner may look for known architectural features, walls, edges, corners, pillars doors and/or windows etc. Optionally, the scanner includes a pan tilt head controlled by a controller to scan key features identified in the modelling. Optionally the scanner is stationary and/or mounted on an autonomous robotic platform. Optionally the controller selects a new position to put the scanner and/or outputs the new position to a user.

### FIELD AND BACKGROUND OF THE INVENTION

The present invention, in some embodiments thereof, relates to a 3D scanner and, more particularly, but not exclusively, to an automatic indoor architectural scanning system.

U.S. patent Ser. No. 10/755,478 to the present inventor appears to disclose, “A method of mapping an interior of a building and/or a device for mapping and/or construction of an interior of a building,” . . . “For example, an autonomous device may find a reference point in a building and/or build an accurate 3D model of the space and/or the building. For example, while mapping the building, the device may use 3D features to orient itself and/or define reference points. For example, a corner where three surfaces meet may serve as a reference point. In some embodiments, the device starts from a starting point (optionally the starting point is arbitrary) and/or finds a defined reference point. For example, the device may include a self-mobile device (e.g., a robot) including a 3D sensor (for example a depth camera and/or 3D Lidar, triangulation depth measuring system, time flight depth measuring system). Optionally the system may include a high precision robotic arm.”

“For example, an autonomous device may find a reference point in a building and/or build an accurate 3D model of the space and/or the building. For example, while mapping the building, the device may use 3D features to orient itself and/or define reference points. For example, a corner where three surfaces meet may serve as a reference point. In some embodiments, the device starts from a starting point (optionally the starting point is arbitrary) and/or finds a fixed reference point. For example, the device follows a surface (optionally the device may seek an approximately planar surface) to an edge thereof. Optionally, the device may then follow the edge to a corner. For example, the corner may serve as a reference point. In some embodiments, the device may define surfaces and/or the edges of surfaces of the domain. Optionally, the device selects and/or defines approximately planar surfaces. Additionally or alternatively, the device may define a perimeter of a surface. For example, a plane may be bounded by other planes and/or its perimeter may be a polygon. Alternatively or additionally, the device is configured to define architectural objects such as wall, ceilings, floors, pillars, door frames, window frames. Optionally, a meshing surface and/or features are defined during scanning. For example, positioning of the scanner and/or the region scanned is controlled based on a mesh and/or a model of the domain built during the scanning process. Optionally, the method performs on the fly meshing of a single frame point-cloud and integrates the results with motion of the sensor.

In some embodiments, a surface may be defined and/or tested using a fitting algorithm and/or a quality of fit algorithm. For example, a planar physical surface may be detected and/or defined by fitting a plane to a surface and/or measuring a quality of fit of a plane to the physical surface. For example, a best fit plane to the physical surface may be defined and/or a root mean squared RMS error of the fit plane to the physical surface. Alternatively or additionally, a more complex shape, for example a curve may be fit to the physical surface. Edges and corners may optionally be defined based on the fit surface and/or on fitting the joints between surfaces. For example, a stop location and/or an edge and/or corner may be defined as the intersection between two and/or three and/or more virtual surfaces (e.g., planes or other idealized surfaces) fit to one or more physical surfaces. In some cases, the defined edge may not exactly correlate to an edge of the physical surface. In some cases, position of an edge and/or corner may be defined in a location where measuring a physical edge is inhibited (e.g., where the edge and/or corner is obscured and/or not sharp) Alternatively or additionally, a surface and/or plane may be defined by a vector (e.g., a normal) and/or changes in the normal over space.”

U.S. patent Ser. No. 10/750,155 appears to disclose, “an image processing technique that combines Lucas-Kanade feature tracking with Speeded-Up Robust Features to perform spatial and temporal tracking using stereo images to produce 3D features can be tracked and identified. The Robust Kalman Filter is an extension of the Kalman Filter algorithm that improves the ability to remove erroneous observations using Principal Component Analysis and the X84 outlier rejection rule. Hierarchical Active Ripple SLAM is a new SLAM architecture that breaks the traditional state space of SLAM into a chain of smaller state spaces, allowing multiple tracked objects, multiple sensors, and multiple updates to occur in linear time with linear storage with respect to the number of tracked objects, landmarks, and estimated object locations. In Landmark Promotion SLAM, only reliable mapped landmarks are promoted through various layers of SLAM to generate larger maps.”

US Patent Application Publication no. 20160104289 appears to disclose, “A system, method, and non-transitory computer-readable storage medium for range map generation is disclosed. The method may include receiving an image from a camera and receiving a 3D point cloud from a range detection unit. The method may further include transforming the 3D point cloud from range detection unit coordinates to camera coordinates. The method may further include projecting the transformed 3D point cloud into a 2D camera image space corresponding to the camera resolution to yield projected 2D points. The method may further include filtering the projected 2D points based on a range threshold. The method may further include generating a range map based on the filtered 2D points and the image.”

U.S. patent Ser. No. 10/096,129 appears to disclose, “A system for registering a three dimensional map of an environment includes a data collection device, such as a robotic device, one or more sensors installable on the device, such as a camera, a LiDAR sensor, an inertial measurement unit (IMU), and a global positioning system receiver. The system may be configured to use the sensor data to perform visual odometry, and/or LiDAR odometry. The system may use IMU measurements to determine an initial estimate, and use a modified generalized iterative closest point algorithm by examining only a portion of scan lines for each frame or combining multiple feature points across multiple frames. While performing the visual and LiDAR odometries, the system may simultaneously perform map registration through a global registration framework and optimize the registration over multiple frames”

International Patent Publication no. WO2020154965 appears to disclose, “A system receives a stream of frames of point clouds from one or more LIDAR sensors of an ADV and corresponding poses in real-time (1401). The system extracts segment information for each frame of the stream based on geometric or spatial attributes of points in the frame, where the segment information includes one or more segments of at least a first frame corresponding to a first pose (1402). The system registers the stream of frames based on the segment information (1403). The system generates a first point cloud map for the stream of frames based on the frame registration (1404).”

International Patent Application no. WO2020230931 appears to disclose, “a robot generating a map on the basis of a multi-sensor and artificial intelligence, configuring correlation between nodes and running by means of the map, and a method for generating a map. A robot according to an embodiment of the present invention generates a pose graph which: comprises a LIDAR branch, comprising one or more LIDAR frames, a visual branch, comprising one or more visual frames, and a backbone comprising two or more frame nodes registered with the LIDAR frames and/or the visual frames; and generates the correlation between the nodes of the pose graph.”

US Patent Application no. 20160189419 appears to disclose, “systems and methods for generating data indicative of a three-dimensional representation of a scene. Current depth data indicative of a scene is generated using a sensor. Salient features are detected within a depth frame associated with the depth data, and these salient features are matched with a saliency likelihoods distribution. The saliency likelihoods distribution represents the scene, and is generated from previously-detected salient features. The pose of the sensor is estimated based upon the matching of detected salient features, and this estimated pose is refined based upon a volumetric representation of the scene. The volumetric representation of the scene is updated based upon the current depth data and estimated pose. A saliency likelihoods distribution representation is updated based on the salient features. Image data indicative of the scene may also be generated and used along with depth data.”

U.S. Pat. No. 8,473,187 appears to disclose, “using a first mobile unit to map two-dimensional features while the first mobile unit traverses a surface. Three-dimensional positions of the features are sensed during the mapping. A three-dimensional map is created including associations between the three-dimensional positions of the features and the map of the two-dimensional features. The three-dimensional map is provided from the first mobile unit to a second mobile unit. The second mobile unit is used to map the two-dimensional features while the second mobile unit traverses the surface. Three-dimensional positions of the two-dimensional features mapped by the second mobile unit are determined within the second mobile unit and by using the three-dimensional map.”

US Patent Publication no. 20140005933 appears to disclose, “A system and method for mapping parameter data acquired by a robot mapping system . . . ” “ . . . Parameter data characterizing the environment is collected while the robot localizes itself within the environment using landmarks. Parameter data is recorded in a plurality of local grids, i.e., sub-maps associated with the robot position and orientation when the data was collected. The robot is configured to generate new grids or reuse existing grids depending on the robot's current pose, the pose associated with other grids, and the uncertainty of these relative pose estimates. The pose estimates associated with the grids are updated over time as the robot refines its estimates of the locations of landmarks from which determines its pose in the environment. Occupancy maps or other global parameter maps may be generated by rendering local grids into a comprehensive map indicating the parameter data in a global reference frame extending the dimensions of the environment.”

U.S. patent Ser. No. 10/520,310 appears to disclose, “a surface surveying device, in particular profiler or 3D scanner, for determining a multiplicity of 3D coordinates of measurement points on a surface, comprising a scanning unit and means for determining a position and orientation of the scanning unit, a carrier for carrying the scanning unit and at least part of the means for determining a position and orientation, and a control and evaluation unit with a surface surveying functionality. The carrier is embodied as an unmanned aerial vehicle which is capable of hovering and comprises a lead, the latter being connected at one end thereof to the aerial vehicle and able to be held at the other end by a user, wherein the lead is provided for guiding the aerial vehicle in the air by the user and the position of the aerial vehicle in the air is predetermined by the effective length of the lead.”

### SUMMARY OF THE INVENTION

According to an aspect of some embodiments of the invention, there is provided a method of 3D scanning using a scanner including: generate a snapshot of a region to be scanned; identifying at least a first key feature in the snapshot or extrapolating the feature to an occluded location; predicating a position from which to measuring the key feature in the occluded location; outputting the position to a carrier.

According to some embodiments of the invention, the method further includes requesting the carrier to move the scanner to the position.

According to some embodiments of the invention, the occluded location includes at least one of a region out of field of view of the snapshot, a region measured at low precision in the snapshot and a region blocked from view in the snapshot.

According to some embodiments of the invention, the identifying includes modeling a domain including at least part of the region and wherein the key feature is a feature includes a feature to which the modelling is sensitive.

According to some embodiments of the invention, the modelling includes creating a boundary representation of the domain.

According to some embodiments of the invention, measuring the feature facilitates closing a polygon of the boundary representation.

According to some embodiments of the invention, the method further includes outputting a result of the modelling.

According to some embodiments of the invention, the method further includes: reducing a point cloud by removing points to which the modelling is not sensitive.

According to some embodiments of the invention, the method further includes:

outputting a result of the reducing.

According to some embodiments of the invention, the feature includes at least one of an edge of a surface and a corner.

According to some embodiments of the invention, the scanning is performed by a stationary scanner and wherein the method further includes requesting the carrier to move the stationary scanner to the position.

According to an aspect of some embodiments of the invention, there is provided a method of 3D scanning including taking a first snapshot of a region; modelling the region based on the snapshot; identifying a key feature in a result of the modelling; and taking a second snapshot of the key feature.

According to some embodiments of the invention, the method further includes outputting a result of the modeling.

According to some embodiments of the invention, the identifying includes modeling a domain including at least part of the region and wherein the key feature is a feature includes a feature to which the modelling is sensitive.

According to some embodiments of the invention, the modelling includes developing a boundary representation of the domain.

According to some embodiments of the invention, measuring the feature facilitates closing a polygon of the boundary representation.

According to some embodiments of the invention, the method further includes: reducing a point cloud by removing points to which the modelling is not sensitive.

According to some embodiments of the invention, the feature includes at least one of an edge of a surface and a corner.

According to an aspect of some embodiments of the invention, there is provided a system for three dimensional scanner including: an actuator; a depth measuring scanner mounted on the actuator for being directed thereby; and a controller configured for receiving data from the depth measuring scanner modelling the data identifying a key feature in a result of the modelling; and directing the actuator for further scanning the key feature.

According to some embodiments of the invention, the system is configured for stationary scanning and the controller is further configured from determining a new position for the scanner for the further scanning, the system further including: a user interface configured for instructing a user or an autonomous robotic platform to move the scanner to a the new position.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) and/or a mesh network (meshnet, emesh) and/or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks might be expected to use completely different methods, e.g., making use of expert knowledge and/or the pattern recognition capabilities of the human brain, which would be vastly more efficient than manually going through the steps of the methods described herein.

Data and/or program code may be accessed and/or shared over a network, for example the Internet. For example, data may be shared and/or accessed using a social network. A processor may include remote processing capabilities for example available over a network (e.g., the Internet). For example, resources may be accessed via cloud computing. The term “cloud computing” refers to the use of computational resources that are available remotely over a public network, such as the internet, and that may be provided for example at a low cost and/or on an hourly basis. Any virtual or physical computer that is in electronic communication with such a public network could potentially be available as a computational resource. To provide computational resources via the cloud network on a secure basis, computers that access the cloud network may employ standard security encryption protocols such as SSL and PGP, which are well known in the industry.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic view of scanning a room in accordance with an embodiment of the current invention;

FIG. 2 is a schematic illustration of a scanner on a robotic actuator in accordance with an embodiment of the current invention

FIG. 3 is a block diagram illustration of a scanner in accordance with an embodiment of the current invention;

FIG. 4 is a schematic illustration of a scanning system mounted on a stationary stand in accordance with an embodiment of the current invention;

FIG. 5 is a flowchart illustration of a method of scanning in accordance with an embodiment of the current invention

FIG. 6 is a flow chart illustration of a method of scanning in accordance with an embodiment of the current invention

FIG. 7 is a flow chart illustration of a method of outputting data in accordance with an embodiment of the current invention;

FIG. 8 is a flow chart illustration of a method for extrapolation in accordance with the current invention;

FIG. 9 is an illustration of selecting a new position in accordance with an embodiment of the current invention;

FIG. 10 is a flow chart illustration of a method of scanning an indoor area in accordance with an embodiment of the current invention;

FIG. 11 is a flow chart illustration of a method of searching for a corner of a surface in accordance with an embodiment of the current invention;

FIG. 12A is a rear side perspective schematic view of scanning a room in accordance with an embodiment of the current invention;

FIG. 12B is a top down perspective schematic view of scanning a room in accordance with an embodiment of the current invention;

FIG. 13 is a schematic view of a scanning system in accordance with an embodiment of the current invention; and

FIG. 14 is a schematic view of a robotic actuator for example, for redirecting and/or repositioning a scanner.

### DESCRIPTION OF SPECIFIC EMBODIMENTS OF THE INVENTION

The present invention, in some embodiments thereof, relates to a 3D scanner and, more particularly, but not exclusively, to an automatic indoor architectural scanning system.

### Overview

An aspect of some embodiments of the invention relates to a 3D scanner for indoor spaces that concurrently scans and models a domain. Optionally, the system identifies a new location for scanning to improve the precision of the model. For example, the system may recognize an area that is covered up and/or was not measured properly and/or suggest a position for the scanner having a better view of the imprecisely measured area. Optionally, the device may recognize a key feature. For example, a key feature may include a surface and/or an edge and/or a corner wherein the model is highly sensitive to the accuracy of measurement of the key feature.

An aspect of some embodiments of the invention relates to a 3D scanner that determines a position from which to continue a scan of an area. For example, the scanner may recognize a portion of an area where an improved scan is desired and/or the scanner may identify a position having an improved view of the area and/or the system may identify a position from which new images may be integrated into an existing dataset. Optionally, the device may output a new position to a carrier (e.g., a robotic platform and/or a robotic actuator and/or user who arranges movement of the device).

In some embodiments, a scanner includes a depth sensor (e.g., a depth camera, Lidar etc.). Optionally, the sensor is mounted on robotic actuator (e.g., a robotic controlled pan and tilt head (e.g., having 2 Degrees of Freedom DOF and/or allowing redirecting of the FOV of the camera) and/or a robotic arm (e.g., having 4 degrees of freedom and/or allowing movement of the camera at high resolution withing a domain)). In some embodiments, a controller (e.g., an electronic processor) analyzes the output from the depth sensor in real-time and controls the movement of the different pan tilt head for directing the scanner. Optionally, the positioning of each axis of the pan tilt head is determined by an ultra accurate positioning encoder—e.g., less than 0.01 degrees accurate and/or between 0.01 to 0.1 degree accurate and/or between 0.1 to 1 degree accurate. For example, positioning accuracy of a robotic arm may range between 0.01 mm to 0.04 mm and/or between 0.04 to 0.1 mm and/or between 0.01 to 1 mm. For example, the movement range of the robotic arm may range between 50 to 200 mm and/or between 200 to 800 mm and/or between 800 mm to 5 m. The modeling algorithm optionally relies on the accuracy of the positioning when building the model. For example, the model may include a boundary representation (B-rep) model. In some embodiments, the pan tilt head and/or robotic actuator might include a moving mirror and/or a joint and/or other mechanics. In some embodiments, the accuracy of the robotic actuator may facilitate accurate movement and/or scanning in areas where the are few landmarks (e.g., a flat area e.g., a wall and/or a floor and/or a ceiling).

On some embodiments, the scanner will output a new position to a low precision carrier. For example, the new position may be sent to a robotic platform and/or a user (e.g., the user may manually move the platform and/or may move the scanner using a low precision robotic platform). Optionally, after movement, the scanner may localize itself at high accuracy based on a visible landmarks and/or features in a model (e.g., modeled edges and/or corners).

An aspect of some embodiments of the current invention relates to a scanner that models while scanning. For example, the scanner may recognize common shapes, surfaces, objects and/or edges while scanning. For example, the scanner may create a B-rep model as it scans. Optionally, the scanner is configured to take advantage of common features on a specific environment. For example, an indoor building scanner may look for known architectural features, walls, edges, corners, pillars doors and/or windows etc.

An aspect of some embodiments of the present invention relates to a 3D scanner that outputs a reduced memory space output. For example, the device may identify a surface and/or a shape in a 3D point cloud image. The device may determine measured points that lie upon the surface and/or reduce redundant points.

### Specific Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

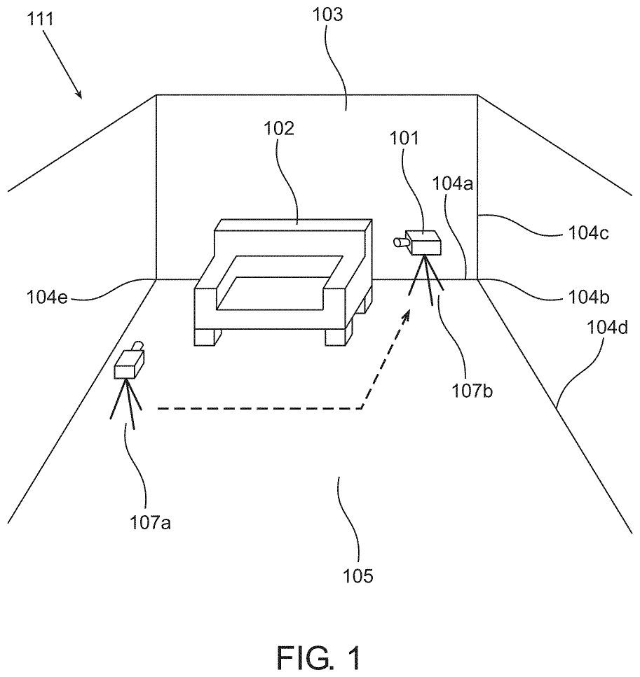

FIG. 1 is a schematic view of scanning a room in accordance with an embodiment of the current invention. In some embodiments, a scanner 101 may be placed in a first position 107a and/or used to scan a space, for example a room 111. Optionally, the scanner will recognize key features, such as a surface (e.g., a wall 103 and/or a floor 105) and/or an edge 104a where the floor 105 meets the wall 103 and/or a corner 104b where two or more edges 104a, 104c, 104d meet. For example, while scanning a processor (e.g., an on board controller) may model the space and/or store data in an efficient format (e.g., a polygon model of surfaces and/or a boundary representation model etc.). Optionally, the scanning system includes a high accuracy actuator (e.g., a pan and tilt head that directs FOV of the scanner 101 around the space at high precision). Additionally or alternatively, the controller may instruct the pan and tilt head to follow key features and/or map them precisely. Optionally, when the scanner is moved, the controller restarts scanning and/or the controller determines a precise location and/or orientation of the scanner with reference to previously scanned features.

For a given scene and an initial sensor position 107a (e.g., a viewpoint), a concavity in the relative geometry may occlude parts of the scene. In some embodiments, this may result in an incomplete model (e.g., holes in the model polyhedron). In some embodiments, concavities may lead to more desired perspectives and/or more repositioning of the scanner in order to complete the model (e.g., a hole-less polyhedron and/or a polyhedron with an acceptable accuracy and/or number of holes and/or size of holes). Optionally a tradeoff problem may be managed by model extrapolation/interpolation, and/or by defining geometric thresholds on occlusion size and/or geometry.

In some embodiments, the controller controls the scanning process to increase the polyhedron around the scanner 101 initial position 107a. Optionally, the resulting polyhedron may not be closed. The resulting polyhedron may optionally be used to define regions of interest to be analyzed. Optionally, a polyhedron may be completed and/or increased by scanning from additional perspectives. For example, an object on the floor 105 may occlude a feature and/or cast a shadow. Optionally, visible parts of the floor 105 may be interpolated “under” the occlusion 102 and/or its shadow. An object may occlude a corner (for example occlusion 102 may occlude corner 104e from a scanner 101 at position 107b). For example, occlusions may include a building element (e.g., a pillar, a counter), a pile of building materials, furniture, a concavity in a surface (e.g., a hole in a wall, a window, a doorway, a nook, a junction of hallways) For example, surrounding parts of the three planes forming the corner may be visible to the scanner 101 and/or the corner location can be extrapolated “behind” the object. In some embodiments, there may be defined a limiting Occlusion size for example a minimal occlusion size to be covered. In some embodiments, there may be an occlusion having a problematic geometry. For example, the controller may define and/or recognize conditions for occlusions that will not be covered. For example, an occlusion may not be covered due to limited access (e.g., a window, a hole in floor/ceiling, a hole smaller than the scanner size). In some embodiments, a feature surface may not be measured properly due to the distance from the scanner and/or due to an oblique angle to the scanner.

In some embodiments, after measuring at a first location 101a, re-localization is performed. For example, the controller may stitch newly scanned features together with previously scanned features. For example, the re-localization method may rely on tracking/re-tracking a previously scanned corner 104b in the scene. The controller may select a new position 107b for scanning keeping one or more corners 104b in the line-of-sight of the scanner. Optionally, the controller may plan a series of scanning positions with keeping reference points visible and achieving a desired accuracy over the scanned space. For example, after completing a scan in a given position, the model may remain incomplete. Optionally, the controller will determine the next position of the scanner in order to fill one or more holes in the model. Optionally, multiple cases are identified. For example, one case may be where additional data is to be measured in the “same room” and/or another case may include the scanning a new room.

In some embodiments, a scan of a room may be incomplete (for example, when the polygon defining the floor and/or ceiling failed to close, for example, when an r-shaped room is scanned from one of the edges).

In some embodiments, another case may include when the further data is to be collected from a “new room” location. In some cases, when scanning a new room, there may not be a lot of data and/or previously measured landmarks in the new room. For example, a “new room” location may be located where visible parts of the floor plane and/or visible parts of a ceiling plane are extruding past the closed polygon defining the previously measured volume. For example, the geometry of the scene surrounding the new location may be unknown—which may result in a sub optimal selection of a position for scanning. For example, when the next volume to be scanned is a corridor, a candidate for a scanning position may be the beginning of the corridor (near and/or within sight previous scanned locations). For example, when the next volume is a room, a preferred location may be near the center of the room. In some embodiments, a BIM (Building Information Model) is available. For example, the controller may use the BIM in determining the next location. Alternatively or additionally, (for example when no BIM is available), a possible mitigation strategy can be to locate the sensor in a position with a relatively large view (e.g., in a central portion of the extruding part of the floor, perform a partial scan (e.g., floor polygon only)) and/or re-determine the next location according to the shape of the floor polygon.

In some embodiments, the sensor 101 has a range limit smaller than one of the dimensions of the scanned volume, and/or the accuracy of the sensor degrades below a desired value beyond a given range. Optionally, the controller will estimate multiple scanning positions (and re-localizations). In some scenarios, the closest feature (e.g., corner) for re-localization might be out of range or too far for the desired accuracy. Possible mitigations may include relying on non-depth localization (2d imagery), and/or fusion with additional sensors.

In some embodiments, the controller may recognize when a feature is occluded. For example, part of the edge 104a may be blocked by an occlusion 102 (e.g., a couch and/or a concave subspace). For example, the scanner may include an output interface configured to instruct a user to move the scanner to another location 101b where the controller predicts that there may be an improved view of the occluded feature.

In some embodiments, the scanner may transmit instructions and/or a notification. For example, the scanner may include a transmitter (e.g., for communication over Bluetooth and/or WIFI network and/or a cellular network). Optionally, the scanner sends a notification to a user when the device has finished scanning from a certain position 107a and/or should be moved to a new position 107b. For example, the scanner may send a map and/or instructions to a computing device (e.g., a cell phone) of the user.

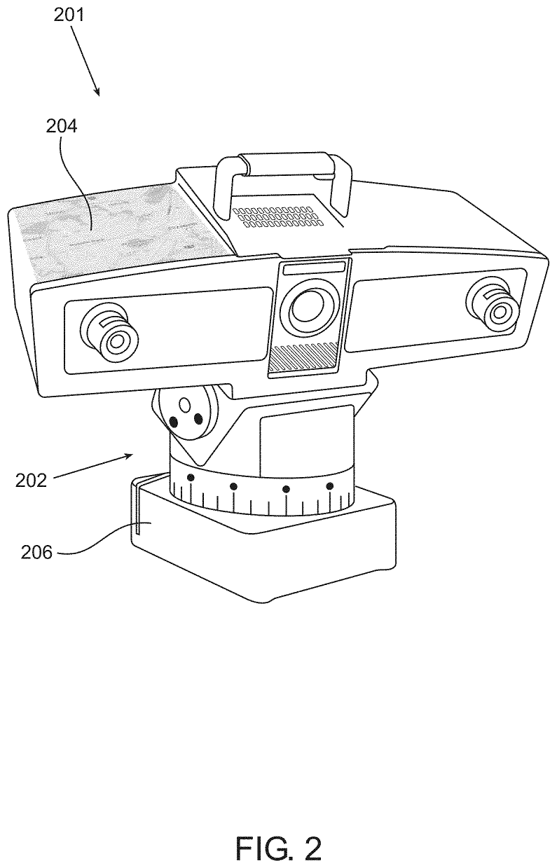

FIG. 2 is a schematic illustration of a scanner on a robotic actuator in accordance with an embodiment of the current invention. In some embodiments a 3D scanner 201 is integrated with the robotic actuator (e.g., pan and tilt head 202). The pan and tilt head 202 optionally stands on a stationary base 206. Alternatively or additionally, the pan tilt head 202 may be mounted on a mobile robotic platform. Optionally, a controller automatically commands the tilt and pan head 202 to direct the scanner 201 around a space (for example, an indoor space). Optionally the controller processes data output of the scanner 201 and/or uses measured data to determine an efficient scan path. For example, the controller may recognize basic shapes and/or key features such as outlines of a surface and/or boundaries (such as straight lines and/or edges). Optionally, the scanner may create a polygon model of surfaces. For example, the controller may direct the pan tilt head 202 to scan along key features at a high density. Optionally, the geometry of parts of a surface that can be found by interpolation may be derived by interpretation without the need for scanning and/or may be scanned at a lower density (e.g., to make sure that there are not unexpected features).

Some embodiments, the controller recognizes when a feature is occluded (for example another object blocks the scanner's view of part of the feature and/or when there is a concave space and/or when a feature is too distant to scan accurately and/or when and oblique angle between the scanner and a surface inhibits accurate measurement). The processor optionally, estimates a new position to place the scanner with a better view of the occluded feature. Optionally, the processor outputs the new position to facilitate moving the scanner. For example, the scanning system may include an output interface 204. For example, interface 204 may output a map of the space and/or an indicator of the new position for the scanner. the scanner may output a direction and/or distance to move the scanner and/or the scanner may output a map showing the known geometry of the space and/or the new position. Alternatively or additionally, the output interface may send a message and/or a map and/or instruction to a carrier over a wireless connection and/or a network. For example, a user may receive instructions and/or the user may manually move the scanner to the new position and/or move the scanner using a remote controlled transporter. Alternatively or additionally, the scanner may be mounted on an independent robotic platform and/or the scanner may output instructions to the platform to move the scanner to the new position.

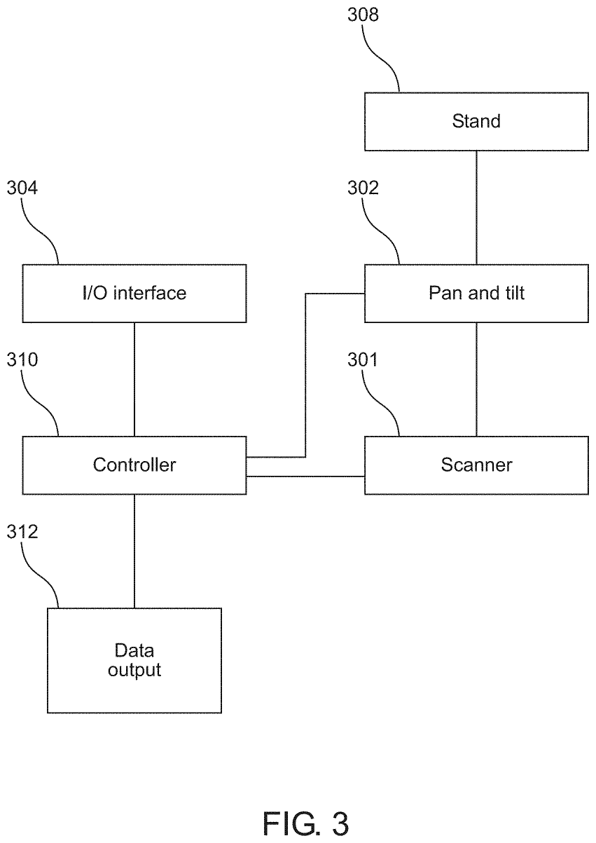

FIG. 3 is a block diagram illustration of a scanning system in accordance with an embodiment of the current invention. In some embodiments, a stationary scanning system may include a robotic actuator 302 (e.g., pan and tilt head) for directing a 3D depth scanner 301 for scanning a space. Optionally, the actuator 302 is controlled by a controller 310. In some embodiments, the controller 310 also receives data from the scanner 301. Additionally or alternatively, the controller 310 also performs modeling functions. For example, the controller 310 may build a boundary representation model based on a 3D point cloud. Optionally, based on the model, the controller directs the scanner to investigate key locations in the scene and/or to reliable landmarks to determine position. For example, the controller 310 may direct the actuator 302 to direct the scanner 301 along an edge of a surface and/or to find a corner. Optionally, the corner may be used as a landmark for determining the position of the scanner 301 and/or other features in the domain. Optionally, the controller 310 may interpolate and/or extrapolate nearby boundaries and/or to predict a location of the corner.

In some embodiments, the corner may be occluded and/or out of range of the scanner 301. Optionally, the controller 310 may further determine a new scanning position from which the corner may be visible and/or from which other landmarks are visible for accurately localizing the scanner 301 and/or so for accurately integrating measured points into the existing model. Optionally, the controller 310 may send a message over a user interface 304 to a carrier nstructing the carrier to move the scanner 301 to the new position. For example, the scanner may have a dedicated user interface 304 (for example, a touch screen and/or a view screen and/or a loudspeaker and/or dials and/or lights etc.). Alternatively, or additionally, the interface 304 may include a communication transceiver and a computing device of the user. For example, the controller 310 may send commands to a computing device of the user which the computing device shows to the user. For example, a notification may be sent notifying the user that scanning in the current location is complete and/or that the scanner 301 should be moved and/or to where to move the scanner 301. Alternatively or additionally, the scanner 301 may be on a mobile base and/or the controller may autonomously move the system from place to place around a domain and/or the user may move the mobile base by remote control.

In some embodiments, the controller 310 may be connected to a data output interface 312. For example, the controller may process raw point cloud data from the scanner 301 and/or send output in a shortened and/or standardized form. For example, the output may be sent as a boundary representation model and/or as a polygon surface representation and/or the point cloud data may be reduced by keeping those points necessary to define features in the domain and getting rid of redundant data (e.g., based on the models of the domain and/or recognized surfaces, edges and/or features).

In some embodiments, a scanner system is designed to stand on a stationary stand 308, for example a tripod and/or an actuator 302. For example, the scanner system may include a standard tripod mount. Alternatively or additionally, the system may be designed for self mobility (for example, being mounted on a robotic platform and/or controlling the platform). Alternatively or additionally, the system may be designed for mobility on a remote controlled platform. For example, the system may be mounted on a remote control vehicle. The controller 310 may optionally select a new position and/or communicate the new position to the user. Optionally, the user may direct the vehicle to the selected position and/or instruct the scanning system to restart scanning in the new position. In some embodiments, when placed in a new position, the scanner system may check if the new position is the position that was requested and/or has a view the desires features. Optionally the system may request a position correction, for example, when the position and/or view are not as desired.

In some embodiments, a scanning system may weight between 3 to 10 kilograms and/or between 100 grams to 500 grams and/or between 500 grams to 3 kg and/or between 10 kg to 30 kg. In some embodiments the length of the system may range between 10 to 50 cm and/or between 1 to 5 cm and/or between 5 to 10 cm and/or between 50 to 200 cm. In some embodiments the width of the system may range between 10 to 50 cm and/or between 5 to 10 cm and/or between 50 to 200 cm. In some embodiments the height of the system may range between 10 to 50 cm and/or between 5 to 10 cm and/or between 50 to 200 cm.

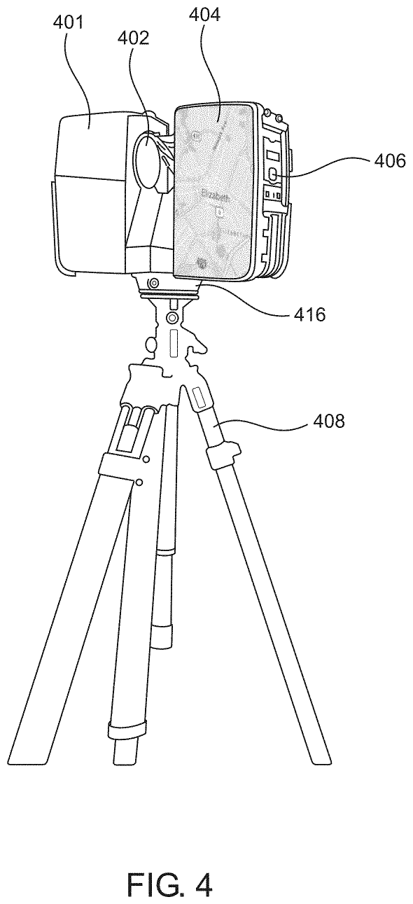

FIG. 4 is a schematic illustration of a scanning system mounted on a stationary stand in accordance with an embodiment of the current invention. In some embodiments, a scanning system may include a standard mount (e.g., a camera mount 416 that fits a standard stationary tripod 408).

In some embodiments a scanning system may include a measurement beam 401 (e.g., a lidar) that is directed by a robotic actuator (e.g., a rotating mirror 402). The system may include a dedicated output interface 404 and/or an input interface 406. For example, the output interface 404 may be configured to output to a carrier a new position to which to move the system. Alternatively or additionally, the system may send output and/or receive input from a personal computing device of a user (for example a cell phone and/or personal computer). For example, the system may include a transceiver for wireless communication with the user device. Alternatively or additionally, the system may send instructions to an independent robotic platform.

As described in other embodiments, the system may include a control that processes point cloud data to form a model and/or may control the pan tilt mechanism to measure data to improve the model and/or may select a new measuring location and communicate the new position to a user.

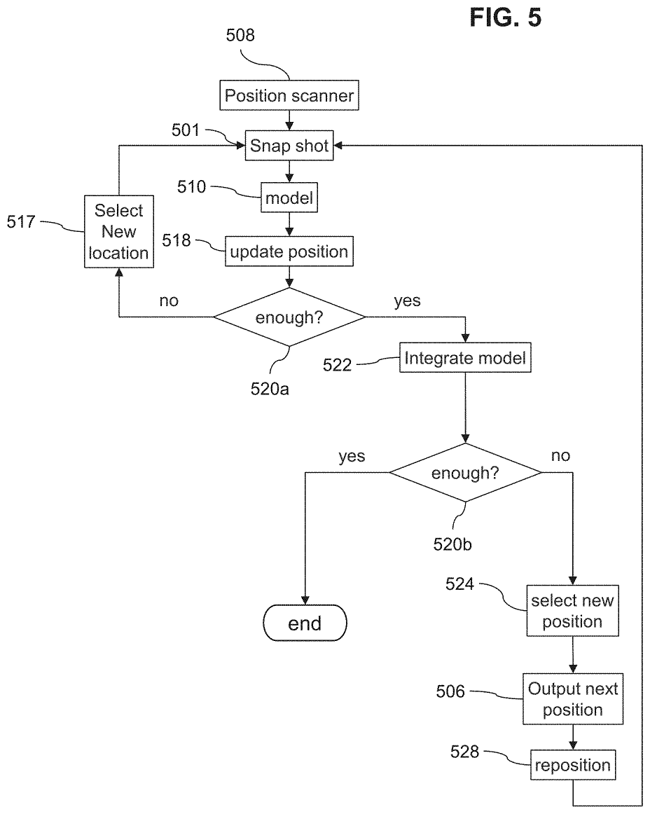

FIG. 5 is a flowchart illustration of a method of scanning in accordance with an embodiment of the current invention. In some embodiments, a system will model and scan concurrently. For example, during scanning a boundary representation model will be created and/or developed. Optionally the model is used to guide further scanning, for example, guiding a robotic actuator to direct a measurement beam to catch key features to improve the model and/or discarding extra data that does not significantly improve the model and/or selecting a new scanning position to improve or complete the model. Optionally, the new position may be output to a carrier (e.g., robotic actuator and/or to a robotic platform and/or to a user). For example, the carrier may move to the scanner to the new position.

In some embodiments, a scanner system is positioned 508 in a domain. Optionally the scanner automatically scans an area visible to the scanner from the fixed position. For example, the scanner may make a 3D snapshot 501 including one or more depth measured points (e.g., a point cloud of 3D data). Optionally, the point data is processed, for example forming a domain model 510 (e.g., a boundary representation model and/or a polygon model surface model and/or polygon model). Optionally, the system may localize 518 the position of the scanner and/or measured points based on the measured data and/or the model. For example, the system may determine the position of the scanner and/or scanned points in relation to measured landmarks. The scan system optionally evaluates the collected data and/or model to see if the domain of view has been characterized enough 520a. For example, if there are features that have not been located (for example a portion of an edge of an identified surface and/or a corner between surfaces) and/or if portions of the visible domain have not been measured to a desired precision, the system may select 517 a location where improved data will improve the model and take a new snapshot 501 in the selected location. For example, the system may select 517 a location to search for a corner by following one or more edges to a location not yet measured and/or to an expected junction. Optionally, once a local area has been modelled enough 520a the system may integrate 522 the local data with a larger scale model and/or with older data. Alternatively or additionally, local data may be integrated 522 with a larger data set during scanning of the local area (for example during the calibration 518 of position).

In some embodiments, after integrating 522 data into a large scale model of a domain, the system may check whether the large scale model covers the domain enough 520b. If so, the scanning may end. Optionally, when there remain portions of the domain that were not yet properly covered and/or were occluded, the system may analyze the domain and/or select 524 a new position from which to scan where it is expected to be possible to improve the model. For example, the new position may have a view behind an occlusion and/or closer to an area that was out of range of a previous scan. Additionally or alternatively, selection 524 of the new position may account for the view of landmarks facilitating proper localizing of the scanner and/or integration 522 of the new data with the existing model. Additionally or alternatively, the system may select 524 multiple positions and/or decide on an order of repositioning to efficiently scan with proper localization information and model integration.

In some embodiments, a next selected position is output 506 to a carrier that repositions 528 the scanning system to the new location. Various forms of communication and/or movement of the system are described in embodiments herein and/or may be included in the current embodiment. Scanning may be restarted at the new position (e.g., by making a new snapshot 501).

In some embodiments, at any time during the scanning process the system may output 506 data (e.g., raw point cloud data, model data and/or reduced point cloud data (e.g., reduced by removing redundant points)). Additionally or alternatively, the system may reduce storage requirements and/or processing requirements by reducing internally stored data and/or performing analysis on a reduced data set and/or model.

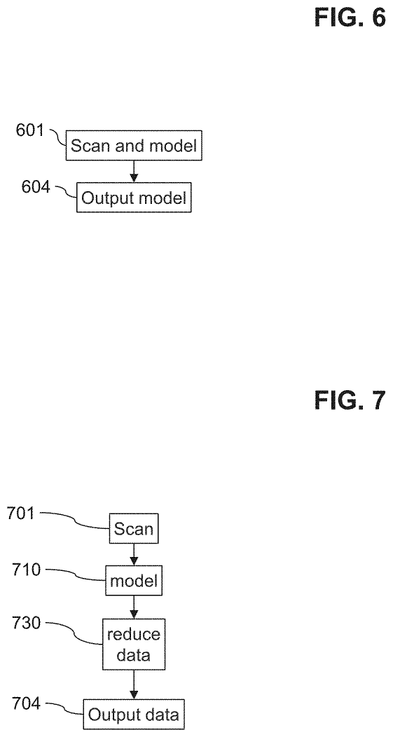

FIG. 6 is a flow chart illustration of a method of scanning in accordance with an embodiment of the current invention. In some embodiments, scanning and modeling 601 are performed concurrently. As the scanning progresses, a model may be created and/or developed and/or used to direct the scanning and/or reduce the computation requirements of the scanning. Optionally, the model data is output 604 to a user.

FIG. 7 is a flow chart illustration of a method of outputting data in accordance with an embodiment of the current invention. In some embodiments, scanning 701 and modeling 710 are performed concurrently. As the scanning progresses, a model may be developed and/or used to direct the scanning and/or reduce the computation requirements of the scanning. Optionally, point cloud data is stored along with a model of the domain. In some embodiments, data may be reduced 730 (e.g., by removing redundant data (for example redundant points that don't add to the accuracy of a model may be removed from a point cloud) and/or storing data in a more efficient format (for example a boundary representation model rather than a point cloud)). Optionally the reduced data is output 704 at various points during the scan and/or at the end of the scan.

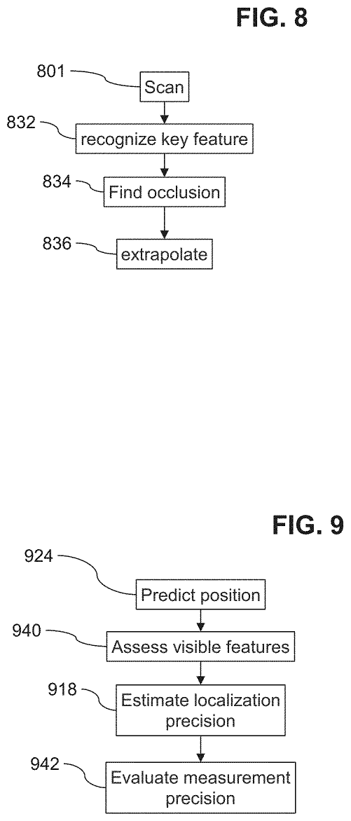

FIG. 8 is a flow chart illustration of a method for extrapolation in accordance with the current invention. In some embodiments, while scanning 801 a domain, a controller will model the domain and/or recognize 832 a key feature. For example, a key feature may include a boundary of a surface (e.g., an edge) and/or a corner (e.g., a meeting of three edges). For example, a key feature may include a geometry whose measurement facilitates closing a polygon of a boundary representation model. In some cases, a key feature may not be known well enough to close a polygon in a boundary representation model. In some cases, there may be a portion of a key feature that is not visible in a snapshot and/or is not measured at a desired precision. Optionally, the source of occlusion that is preventing seeing and/or measuring the feature will be identified 834. For example, it may be found that the edge passes beyond the field of view and/or range of a sensor. For example, it may be found that there is an object blocking view of the feature. For example, it will may be found than an angle of the object with respect to the scanner inhibits accurate scanning. Optionally, extrapolation 836 will be used to determine a new location to measure to better constrain the occluded feature. Optionally, the new location may then be scanned 801. For example, extrapolation may include tracking a feature (e.g., an edge) to an unmeasured area and the predicting its location and/or continuation in the unmeasured area. Once a location of the key feature or portion thereof is estimated, the system may scan 801 that location. Additionally or alternatively, the scanner may select a new position and/or be moved to the new position. For example, the new position may have a better view of the location and/or an unblocked view of the location.

FIG. 9 is an illustration of selecting a new position in accordance with an embodiment of the current invention. In some embodiments, a controller may predict 924 a position from which to get a better view of a location that is to be measured. Optionally, the system will assess 940 what previously measured features are visible from the new position. Based on a predicted quality of measurement of the new location and landmarks from the new position, the system will estimate 918 a localization precision for the new position of the scanner and/or evaluate 942 a likely precision for measurements made at the target location from the new position. Based on the results it may be selected to scan the target location from the new position and/or a different position and/or more landmarks may be sought before scanning the target location.

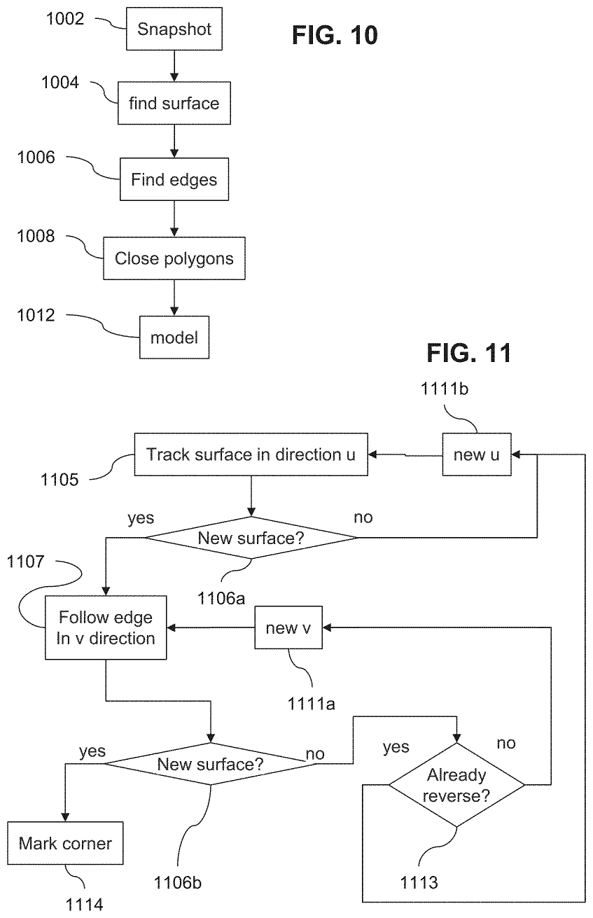

FIG. 10 is a flow chart illustration of a method of scanning an indoor area in accordance with an embodiment of the current invention. In some embodiments, a device will begin mapping a domain by taking a snapshot 1002 of field of view (FOV) of a sensor assembly in the domain. For example, the snapshot 1002 may be an image the field. For example, the image may be made up of point measurements distributed over the FOV. For example, each point measurement may include a 3D coordinate and/or a light level and/or a color (e.g., a level of red, green and/or blue).

In some embodiments, device will optionally find 1004 a surface in the snapshot. For example, the device may find 1004 a planar surface. Note that a curved surface and/or an uneven surface may be defined as planar over some small area and/or approximately planar over a large area. For example, the surface may be defined as planar over a domain where an angle of a normal to the surface does not change more than 1% and/or 5% and/or 10% and/or 30%. For example, the surface may be defined as planar in an area where a difference between the location of the surface and a plane is less than 1/20 of the length of the surface and/or less than 1/10 the length and/or less than ⅕ the length. Unless otherwise stated, a surface may be defined as a plane when a difference (e.g., RMS difference) is less than a threshold. Optionally, the fitting test (e.g., the threshold) may be fixed and/or range dependent. For example, for some sensor types the test may be range dependent and/or for other sensors it may be fixed). Optionally the device will build a mesh of one or more surfaces in the snapshot. For example, a mesh may include a set of connected polygons used to describe a surface. Approximately planar surfaces may be identified from the mesh. A planar mesh may contain one or more holes. For example, a hole in a planar mesh may be a non-planar area, and/or an actual hole in the surface. Hole boundaries are optionally represented as closed polygons.

In some embodiments, the device may find 1006 edges of one or more surface in the domain. Unless otherwise stated, an edge may be defined as the Intersection line of shapes (e.g., planes) fit to a pair of physical surfaces and/or a corner may be defined as the Intersection point of three fit shapes. Alternatively or additionally, an edge may be defined as a line (optionally the line may be straight and/or curved) along which a normal to the surface changes suddenly. Unless otherwise stated the edge is a feature that continues at least 1/10 the length of the current FOV and/or the sudden change is defined as a change of at least 60 degrees over a distance of less than 5 mm. Alternatively or additionally, the line may be required to be straight (e.g., not change direction more than 5 degrees inside the FOV). Alternatively or additionally, the edge may be a feature that continues at least 1/100 the length of the FOV and/or 1/20 and/or ⅕ and/or ⅓ the length and/or at least 1 mm and/or at least 1 cm and/or at least 10 cm and/or at least 100 cm. Alternatively or additionally, the sudden change may be defined as a change of angle of the normal of at least 30 degrees over a distance of a less than 5 cm. Alternatively or additionally the change in angle may be defined as greater than 10 degrees and/or greater than 60 degrees and/or greater than 85 degrees and/or between 85 to 95 degrees and/or between 88 to 92 degrees and/or greater that 95 degrees and/or greater than 120 degrees and greater than 150 degrees. Optionally the distance may be over less than 1 mm and/or over between 1 to 5 mm and/or over 5 mm to 1 cm and/or between 1 to 5 cm and/or between 5 to 25 cm.

In some embodiments, a corner may be defined as a meeting of three edges in a volume of radius less than 10 mm each edge leading out of the volume at an angle differing from each other edge by at least 30 degrees. Alternatively or additionally, the corner may be defined within a volume of radius of less than 1 mm and/or less than 1 cm and/or less than 10 cm there are at least three edges leading out of the volume at angles differing by at least 10 degrees and/or at least 30 degrees and/or at least 60 degrees and/or at least 80 degrees and/or at least 85 degrees. Alternatively or additionally, a corner may be defined as a meeting of three planar surfaces. For example, the within a volume of radius of less than 1 mm and/or less than 1 cm and/or less than 10 cm there are at least three planar surfaces having normals at angles differing by at least 10 degrees and/or at least 30 degrees and/or at least 60 degrees and/or at least 80 degrees and/or at least 85 degrees, each surface having a surface area of at least the radius of the circular volume squared and divided by 4 and/or divided by 8 and/or divided by 12 and/or divided by 16.

In some embodiments, edges may be defined to close 1008 the perimeter of a surface. For example, a perimeter of a surface may be defined as a polygon having approximately straight edges and/or corners. Optionally, a domain may be modeled 1012, for example, by segmenting objects. For example, segmenting may include differentiating between discrete objects and/or defining the objects. For example, a planar surface at a lower portion of domain and/or having a normal that is vertically upward may be defined as a floor and/or a planar surface having a normal that is horizontal may be defined as a wall. For example, a pillar may be defined by its closed edge on a floor and/or a on a ceiling and/or its height and/or its vertical sides.

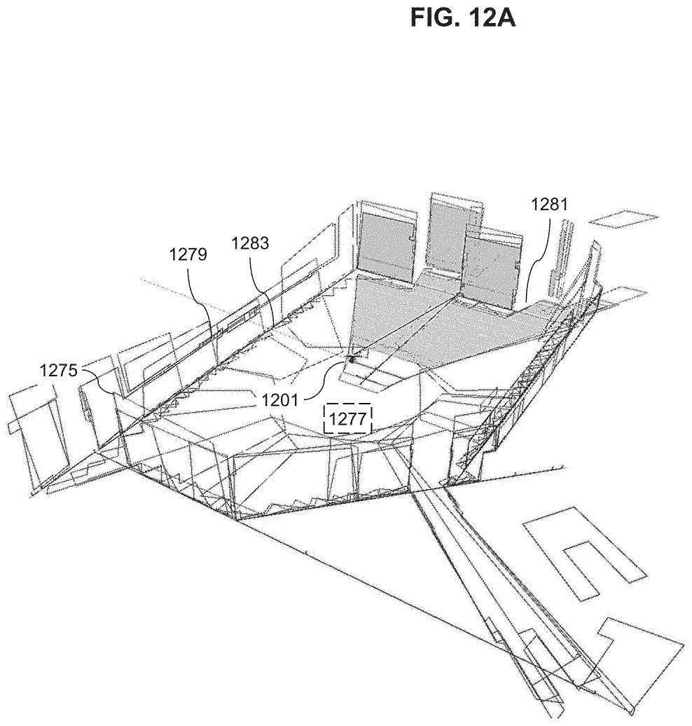

FIG. 11 is a flow chart illustration of a method of searching for a corner of a surface in accordance with an embodiment of the current invention. For example, once a device has selected a surface, a sensor may track 1105 along the surface in a defined direction “u” (optionally tracking may including moving the entire device along the surface and/or moving the sensor with respect to the device and/or by directing the field of view of the sensor without actually moving the sensor). Tracking 1105 may continue until a stop condition is reached (e.g., a stop condition may include an edge of a fit shape and/or a change beyond some threshold value in the angle of a normal to the surface for example the threshold value may be 10% and/or 30% and/or 60% and/or 85% and/or 90%). At the stop location the device optionally takes a new snapshot and/or checks 1106a the snapshot includes a new surface (e.g., if an edge of the surface has been reached). For example, an edge of a planar surface may be defined as a location where a new plane (second plane, non-conforming to the first one) is present in the snapshot at a specified scale. If no such second plane exists, the device optionally selects 1111b a new tracking direction (u) in the original plane and and/or re-starts tracking 1105. If such a second plane exists, the device optionally selects a direction along the line intersection of the two planes and/or tracks 1107 the line until stop condition is reached. At a stop location, the system optionally takes a new snapshot and checks 1106b a new surface has been reached (e.g., if a corner has been reached). For example, a corner may be defined as an intersection between the two surfaces defining the edge and a new surface (for example a third plane, non-conforming to the previous two). If no such third plane exists, the device may choose 1111a a new direction (e.g., reverse direction (v=−v)) and track 1107 along the line in the new direction until a stop condition is reached. At the new stop location, the device optionally takes a new snapshot. If still no such third plane exists, the device may select a new tracking direction (u) in the original plane and/or re-start tracking 1105 along the surface in search of a new edge. If a third plane exists, the device optionally recognizes 1114 the intersection of the 3 planes as a corner.

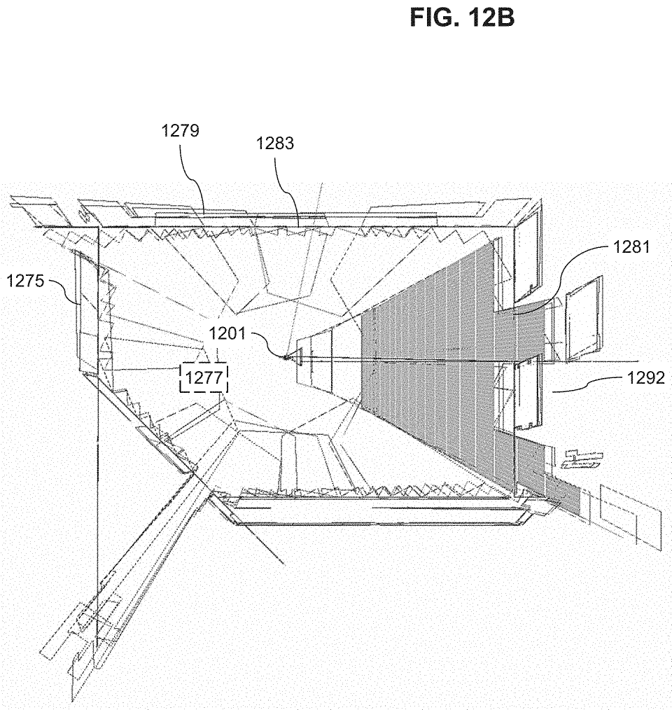

FIG. 12A is a rear side perspective schematic view of scanning a room in accordance with an embodiment of the current invention. FIG. 12B is a top down perspective schematic view of scanning a room in accordance with an embodiment of the current invention. In some embodiments, a scanner 1201 is placed in a room and/or scans from a stationary position. Optionally, during scanning, the system creates and/or develops a model the domain. For example, the system creates and/or develops a mesh of polygons 1275 to represent detected surface (e.g., a floor 1277 and/or a wall 1279) and/or to define the boundaries of spaces (e.g., a door 1281). Optionally, in critical areas (for example a boundary between surfaces [e.g., an edge 1283 were two surface (e.g., wall 1279 and floor 1277) meet] the scanner 1201 directs higher density scanning coverage.

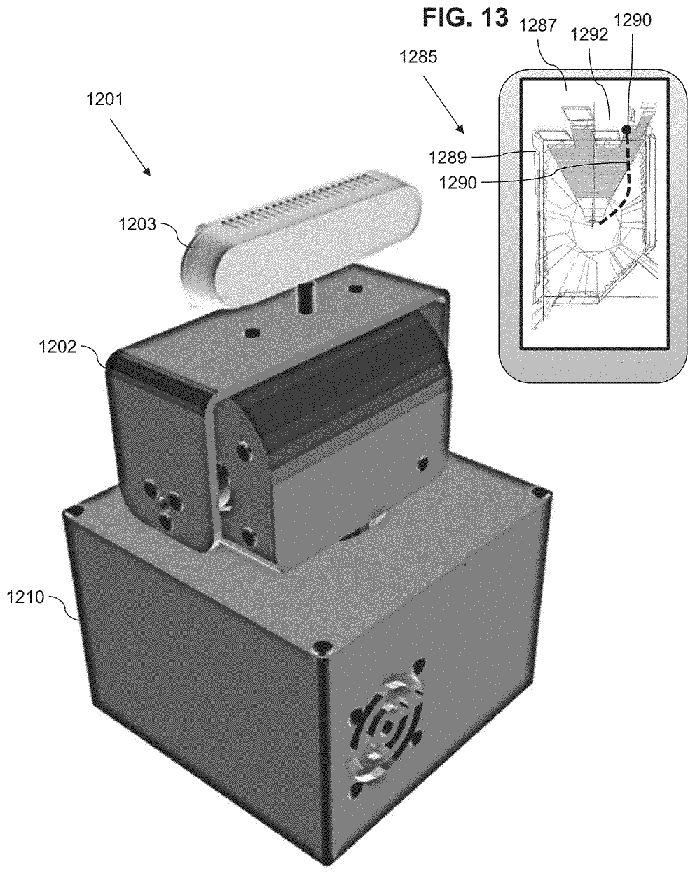

FIG. 13 is a schematic view of a scanning system in accordance with an embodiment of the current invention. For example, the system may include a scanner 1201 and/or an input/output interface 1285. Optionally, scanner 1201 includes a sensor 1203 mounted on a pan-tilt head 1202. The scanner may be controlled by a local processor 1210 and/or a remote processor (for example, the local processor 1210 may include a transceiver and/or be connected to the remote processor and/or interface 1285 via a wireless network). For example, the remote processor may include a processor of interface 1285 and/or a remote server (e.g., accessed over the Internet).

In some embodiments, interface 1285 may include a personal computing device of a user (e.g., a smartphone). Interface 1285 may include a touch screen 1287. For example, processor 1210 may send data including a model of the room to interface 1285. Alternatively or additionally, processor 1210 and/or a remote processor may generate instruction 1290 for the user (for example instruction 1290 to move to the scanner 1201 to a new position 1292 for further scanning of area (e.g., a hallway adjacent to the room in which the scanner is current located) that is not properly covered in the current model. Optionally, the user may manually move the scanner 1201 to the new position 1290. Alternatively or additionally, the user may give instructions to a remote control robotic platform to move the scanner 1201 to the new position 1290 (e.g., the scanner 1201 may be mounted on the remote control platform and/or the platform may be separate from the scanner 1201). Alternatively or additionally, the processor 1210 (and/or a remote processor) may give instructions to an autonomous robotic platform to move the scanner 1201 to the new position 1290 (e.g., the scanner 1201 may be mounted on the autonomous platform and/or the platform may be separate from the scanner 1201). Optionally, instructions may be sent to a remote and/or autonomous platform over a hard wired connection and/or over a wired connection.

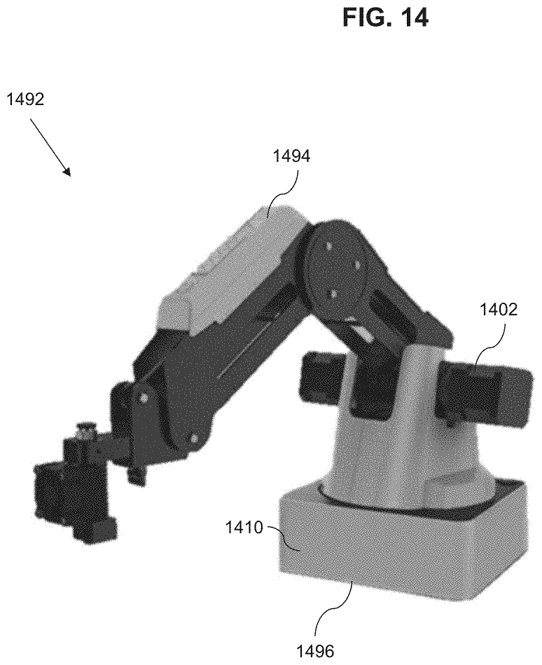

FIG. 14 is a schematic view of a robotic actuator for example, for redirecting and/or repositioning a scanner. For example, an actuator 1492 may include a robotic arm 1494. Optionally the arm 1494 is mounted on a pan and tilt mechanism 1402. Alternatively or additionally, the actuator 1492 may not include a pan and tilt mechanism. In some embodiments, the actuator may be connected a base 1496. For example, the base 1496 may supply a heavy and/or stable portion and/or a shock absorber and/or vibration reducer. Alternatively or additionally, the base 1496 may include a connector (for example for connecting the system to a tripod). Optionally, the actuator 1492 includes a controller 1410. Optionally, the controller controls and/or measures movement of the arm 1494 and/or tilt head 4102. For example, controller 1410 is mounted in base 1496. Optionally, controller 1401 include a communication system (e.g., a wireless transceiver and/or a wired connect). For example, the communication system may connect the controller 1410 to the scanner and/or a server. Optionally, data received from the communication system may include instructions (for redirecting and/or repositioning the scanner) and/or model data).

It is expected that during the life of a patent maturing from this application many relevant technologies (for example, measurement and/or scanning technologies) will be developed and the scope of the terms are intended to include all such new technologies a priori.

As used herein the term “about” refers to ±5%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. When multiple ranges are listed for a single variable, a combination of the ranges is also included (for example the ranges from 1 to 2 and/or from 2 to 4 also includes the combined range from 1 to 4).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of 3D scanning using a scanner comprising:
generate a snapshot of a region to be scanned;
identifying at least a first key feature in the snapshot and extrapolating said feature to an occluded location;
predicating a position from which to measuring said key feature in said occluded location;
outputting said position to a carrier

2. The method of claim 1, further including requesting said carrier to move said scanner to said position.

3. The method of claim 1, wherein said occluded location includes at least one of a region out of field of view of said snapshot, a region measured at low precision in said snapshot and a region blocked from view in said snapshot.

4. The method of claim 1, wherein said identifying includes modeling a domain including at least part of said region and wherein said key feature is a feature includes a feature to which said modelling is sensitive.

5. The method of claim 4, wherein said modelling includes creating a boundary representation of said domain.

6. The method of claim 5, wherein measuring said feature facilitates closing a polygon of said boundary representation.

7. The method of claim 4, further comprising outputting a result of said modelling.

8. The method of claim 4, further comprising: reducing a point cloud by removing points to which said modelling is not sensitive.

9. The method of claim 8, further comprising: outputting a result of said reducing.

10. The method of claim 1, wherein said feature includes at least one of an edge of a surface and a corner.

11. The method of claim 1, wherein said scanning is performed by a stationary scanner and wherein the method further comprises requesting said carrier to move said stationary scanner to said position.

12. A method of 3D scanning comprising
taking a first snapshot of a region;
modelling said region based on said snapshot;
identifying a key feature in a result of said modelling; and
taking a second snapshot of said key feature.

13. The method of claim 12, further comprising outputting a result of said modeling.

14. The method of claim 12, wherein said identifying includes modeling a domain including at least part of said region and wherein said key feature is a feature includes a feature to which said modelling is sensitive.

15. The method of claim 14, wherein said modelling includes developing a boundary representation of said domain.

16. The method of claim 15, wherein measuring said feature facilitates closing a polygon of said boundary representation.

17. The method of claim 14, further comprising: reducing a point cloud by removing points to which said modelling is not sensitive.

18. The method of claim 12, wherein said feature includes at least one of an edge of a surface and a corner.

19. A system for three dimensional scanner comprising:
a robotic actuator;
a depth measuring scanner mounted on said actuator for being directed thereby; and
a controller configured for
receiving data from said depth measuring scanner
modelling said data
identifying a key feature in a result of said modelling; and
directing said pan tilt head for further scanning said key feature.

20. The system of claim 19 wherein said system is configured for stationary scanning and said controller is further configured from determining a new position for the scanner for said further scanning, the system further comprising: a carrier interface configured for instructing a carrier to move said scanner to a said new position.
